(19) United States
(12) Patent Application Publication
(10) Pub. No.: US 2007/0272158 A1
(43) Pub. Date: Nov. 29, 2007

(54) Method for Providing Data for a Control System for a Milk Cooling Arrangement of a Milking System, and Method For Cooling Milk In a Milk Cooling Arrangement and Control System for a Milk Cooling Arrangement

(75) Inventor: Peter Kaever, Oelde (DE)

Correspondence Address: Jeffry W. Smith;Smith Law Office, 440 Science Drive, Ste. 302, Madison, WI, 53711, US

(73) Assignee: WESTFALIASURGE GMBH, Bonen (DE)

(21) Appl. No.: 10/568,060

(22) PCT Filed: Aug. 13, 2004
(86) PCT No.: PCT/EP04/09086

§ 371 Date: Feb. 15, 2007

(30) Foreign Application Priority Data
Aug. 13, 2003 (DE) 103 37 264.4

(51) Int. Cl. A01J 9/04

(52) U.S. Cl. 119/14.08

(57) ABSTRACT

In order to improve the functionality of a cooling arrangement (4), the invention provides a method for providing data for a control system for a milk cooling arrangement (4), a method for cooling milk in a milk cooling arrangement, and a control system. Data, which are relevant to the cooling tank and which are at least specific to the milk at least two milking stations, are determined for the control system of a milk cooling arrangement of a milking system and are provided to said control system. At least one characteristic quantity is determined from this data, and the milk cooling arrangement is activated when at least one characteristic quantity lies outside a tolerance zone, particularly when it exceeds a predetermined threshold value. Shorter cooling times and an improved use of resources are achieved due to the interaction of the milking parlor control with the control system of a milk cooling arrangement. In addition, the invention enables an operator to set parameters and log the operation of the milk cooling arrangement in a convenient manner.

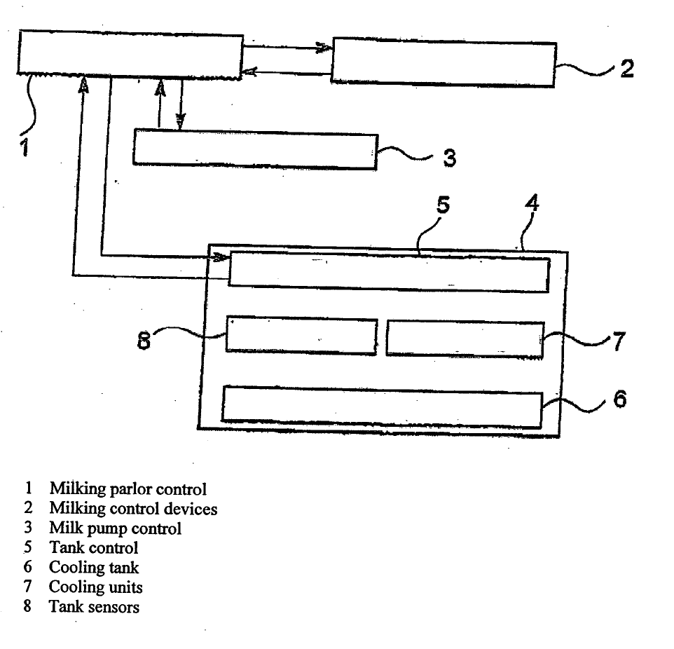

The object of the invention refers to a method for providing data for a control system of a milk cooling arrangement with at least one cooling tank of a milking system, a method for cooling milk in a milk cooling arrangement as well as a control system of a milk cooling arrangement with at least one cooling tank. The invention can be used in conventional milking systems, in semi-automatic and fully-automatic milking systems, as well as in robot-supported milking systems.

The invention can be used not only in milking systems for milking of cows, but also for milking systems for milking sheep, goats, horses, camels, buffalo, yaks, elk and other milk-yielding animals.

In the known milking systems, the milk milked from animals is collected in a cooling tank and stored until the content of the tank is removed and introduced to further processing. In order to ensure that during the storage of milk its properties are retained, it is necessary to cool the milk as rapidly as possible but as a maximum within three hours to 4° C. When the temperature is too low, this may lead to decomposition phenomena in the milk. In frozen milk, the fat particles are damaged and the amount of free fatty acids in the milk increases, whereupon a watery milk is produced. If the temperature is too high, there is a danger of development of germs so that the collected milk is no longer suitable for human consumption.

When freshly-milked milk, which has a temperature that is clearly above the storage temperature, is introduced into the cooling tank, the temperature inside the cooling tank may increase above the temperature prescribed for storing the milk. This occurs especially when little milk is present in the cooling tank or when the cooling tank was empty previously.

Depending on the milking system, the cooling tank and the corresponding cooling devices have different requirements. In conventional milking systems in which, as a rule, milking is performed twice a day, large amounts of milk are produced twice a day during the milking duration. In automatic milking systems, especially in robot-supported milking systems in which the animals have free access to the milking system, the milked milk is obtained almost continuously. This results in the necessity to begin cooling even for small amounts of milk.

In order to avoid temperature stratification in the milk within the cooling tank, it is also known that the cooling tank can be equipped with a stirring mechanism. In order to shorten the time span until an orderly functioning of the stirring mechanism is reached and the cooling is turned on, a buffer tank, into which the milked milk arrives, is arranged before the cooling tank.

It is also known that the milked raw milk is subjected to pre-cooling before it is introduced into the cooling tank. Plate coolers in which the raw milk gives off a part of its heat to cooling waters serve this purpose. The heated cooling water can be used as drinking water.

A milk cooling arrangement with at least one cooling tank of a milking system is known from DE 100 39 014 A1. The cooling tank has a wall in which a cooling floor is arranged. The cooling occurs with direct evaporation of a coolant circulating in one or several evaporator cooling floors of the tank wall with connection to a cooling machine, whereby the coolant decompressed in the cooling machine is evaporated there, while cooling the milk located above the evaporator cooling floor. Turning the cooling machine on and off is done with a thermostat with temperature sensors, which is arranged in the evaporator-cooling bottom on a point in the milk cooling tank which is as low as possible, and the surface temperature existing there is measured and/or the mixing temperature produced is measured. For immediate cooling of amounts of milk flowing in an area of the cooling bottom which is to be covered with milk, evaporator floor segments as evaporator cooling floor are arranged next to one another. These evaporator floor segments can be turned on and turned off individually. They have individual cooling circuits. In order to control the temperature of the evaporator floor segment or segments, devices are provided which, as a function of the surface temperature of the evaporator floor segment and/or of the evaporation temperature and/or of the partial pressure of the coolant in the evaporator floor segments, produce throttling and/or turning on and turning off of the motor compressors of the cooling machines.

Due to the fact that the thermostat in the evaporator cooling floor is at as deep a point in the cooling tank as possible, there is a danger that the time duration between the time at which the milk arrives into a partially-filled cooling tank and the activation of the cooling machine is so long that during this time the milk quality may be affected adversely.

With this as our point of departure, the goal of the present invention is to create a method for providing data for a control system of a milk cooling arrangement with at least one cooling tank of a milking system, with the aid of which the response behavior of the milk cooling arrangement to the changing milk stream is improved.

According to the invention, this task is solved by a method for providing data for a control system of a milk cooling arrangement with at least one cooling tank of a milking system. Advantageous further developments and embodiments of the method for providing data is the object of the dependent claims.

The method according to the invention for providing data for a control system of a milk cooling arrangement with at least one cooling tank of a milking system is characterized by the fact that at least cooling-tank-related data as well as at least milk-specific data on at least some milking stations are determined and these are made available to the control system.

Due to the fact that, in addition to cooling-tank-related data the control system of a milk cooling arrangement is also provided with at least milk-specific data of at least one milking station, the control system can generate standards for the control of the milk cooling arrangement, especially of the cooling tank. With the aid of these standards, control of the arrangement and preferably of the cooling tank is made possible at a very early point in time, because now it is no longer absolutely necessary to detect new inflowing milk by sensors in the cooling tank. By providing data for a control system, the possibility is created that this control system reacts based on the data made available beforehand, that is, before possible sensors in the cooling tanks indicate disturbances or increasing temperatures.

With the aid of these measures, not only the control is improved but the quality of the cooling can also be improved, which has a favorable effect on the storage of the milk.

Especially, it is proposed that the milk-specific data, information about the amount of milk milked, temperature, flow velocity and/or specific heat capacity of the milk are obtained. This information is frequently available already at the milking station. For example, with the aid of this information it is possible to prepare the cooling tank for the soon entering milk and for the amount of heat related to that. This means that the adjustment of the output of the milk cooling arrangement, especially of the cooling tank, to the actual demand of cooling performance is possible. The control of the cooling and mixing processes which are involved in the cooling of the milk are also included in the coordination.

Considering that the control system of a milk cooling arrangement is no longer dependent exclusively on the sensors within the cooling tank, but has information available about the amount of milk and of its temperature, that is, about the amount of heat to be expected in the future, it can prepare for the cooling of the incoming amount of milk before the sensors of the cooling tank go beyond the required threshold values. Since usually the cooling tank is further removed from the milking stations and a certain time elapses before the milk arrives from the milking station to the cooling tank, according to the method of the invention, this time can be utilized to prepare the milk cooling arrangement to the task before it. If the milk cooling arrangement has a cooling device which comprises at least one cooling agent storage, the cooling agent storage can be filled completely, by and large, when a large amount of milk or amount of heat is to be expected.

In milk cooling arrangements with variable cooling performance, this can be also maximized in anticipation in order to take into consideration the conditions to be expected.

With the control system, not only milk-specific data but also cooling-tank-related data are taken into consideration. These data contain information about the amount of milk present in the cooling tank, the holding capacity of the cooling tank, the remaining capacity of the cooling tank, temperature, cooling performance, and/or status of a cooling device. Such information is introduced in the form of parameters into the control system and then these are processed by the control system as signals.

The amount of milk obtained in a milking process depends on the individual animal. It also changes with the state of lactation of the animal. During the initial phase of lactation, the amount of milk given off by an animal is greater than towards the end of lactation of the animal. Therefore, it is advantageous when the control system also provides data about the individual animal. As a result of this, the milk cooling arrangement can be adjusted to the temporal task it faces and can be shifted to a very early point in time, that is, under certain circumstances, even to before the beginning of a milking process.

When an animal is recognized at a milking station and it has been determined that no abnormal behavior is expected from the animal, then, based on historical data about the animal, the amount of milk expected can be determined. This can be transmitted to the control system as a predictive value. Optionally, this predicted value can be assigned a safety factor which takes into consideration an uncertainty about the amount of milk given off by the particular animal, so that the cooling performance will not be set too high. Since the cooling is related to energy consumption, this energy consumption determines the cost of the operation of the milk cooling arrangement. This is particularly important especially when the cooling pumps and the compressor of a milk cooling arrangement run in the optimum region. In addition to providing data about individual animals, it is advantageous when the control system is provided group-specific and herd-specific data, statistical data and/or milking station management data.

Especially in robot-supported milking systems in which the animals can go to the milking system freely, a time-distribution of the amounts of milk expected can be determined from group-specific and herd-specific data. These data contain information about the frequency of going to the milking system by the individual animals as well as the time span between two milking processes. From this it can be determined, for example, when a majority of animals go to the milking system and the amount of milk that will probably be obtained. Already from the anticipated data, preparative measures can be performed at the milk cooling arrangement. This can be, for example, the preparation of an additional cooling tank when it is determined that the amount of milk expected is greater than the residual capacity of another cooling tank.

If the milk cooling arrangement has several cooling tanks, then the control system can also assume the coordination of the milk flow from the milking stations to the cooling tanks. In this case it is helpful to provide cooling-tank-related data which are, for example, the current tank capacity, which can be calculated from the capacity of the cooling tank and the actual amount of filling. With the aid of the internal characteristic quantities of the cooling tank, for example, the state of filling, remaining capacity, temperature, cooling performance, status of the cooling aggregate, etc., by controlling the milking station, the loading of the cooling tank with the milked amount of milk can be coordinated and optimized.

In addition to providing data for a control system of a milk cooling arrangement, one of the goals of the present invention is to propose a method for cooling milk in a milk cooling arrangement, providing effective cooling. Especially savings of energy is one of the aims.

This task is solved according to the invention by a method of cooling of milk in a milk cooling arrangement with at least one cooling tank and at least one cooling device of a milking system with the characteristics of claim 5. Advantageous further developments and embodiments of the methods are objects of the dependent claims.

According to the method of the invention for the cooling of milk in a milk cooling arrangement, it is proposed that determination of the amount of milk milked in at least one milking station as well as a temperature of the amount of milk milked which is led at least partly to at least one cooling tank be determined. The amount of milk as well as the temperature of the amount of milk which is located in the cooling tank into which the milked amount of milk is passed is determined. Starting from this data at least one characteristic quantity is determined. It checks whether the characteristic quantity is within a tolerance field, especially the characteristic quantity is compared with a predetermined threshold value. Activation of the cooling device occurs when the at least one characteristic quantity is outside a tolerance field, especially when the characteristic quantity exceeds a predetermined threshold value.

By performing the method according to the invention it is achieved that, for example, a cooling device of a milk cooling arrangement is activated at a very early point in time when the at least one characteristic quantity lies outside a tolerance field. If this is not the case, then the milked amount of milk can arrive into the cooling tank without activation of the cooling device. Such a situation exists, for example, when the amount of milk or the amount of heat that has to be removed from the milk is very small in comparison to the amount of milk in the cooling tank. If needed, a stirrer can be turned on which results in making the milk temperature in the tank uniform.

The method according to the invention also provides the advantage that the cooling performance is utilized only when this is actually needed. From the point of view of energy, this conduction of the method has numerous advantages, especially the amount of energy necessary for operating the milk cooling arrangement can be minimized.

According to an advantageous embodiment of the method, it is proposed that the amount of heat of the milked amount of milk be determined as at least one characteristic quantity. This is the amount of heat that must be removed from the milked milk in order to reach the temperature in the cooling tank. From this characteristic quantity it can be determined how the milk cooling arrangement is to be controlled so that the excessive amount of heat in the material to be cooled, that is, in the amount of milk milked, is removed. In an especially simple embodiment, thus, for example, the opening time of an expansion valve for a coolant can be determined.

In addition to or instead of determining the amount of heat of the milked milk, a theoretical mixing temperature in the cooling tank can be determined as the characteristic quantity. This theoretical mixing temperature can be determined approximately using the following equation:

$${T}_{m} = {T}_{0} + \frac{( {m}_{T} {c}_{T} + {m}_{MT} {c}_{M} ) ( {T}_{T} - {T}_{0} ) + {m}_{M} \cdot {c}_{M} ( {T}_{M} - {T}_{0} )}{{m}_{T} {c}_{T} + {m}_{MT} \cdot {c}_{M} + {m}_{M} \cdot {c}_{M}}$$

where the symbols have the following meanings:

Tₘ mixing temperature,

T₀ reference temperature,

m_{T} mass of tank,

c_{T} specific heat capacity of the tank,

m_{MT} mass of the milk in the tank,

T_{T} temperature of the tank and milk,

m_{M} mass of milked milk,

c_{M} specific heat capacity of the milk and

T_{M} temperature of the milked milk

If the theoretical mixing temperature is above a threshold value, then the cooling installation is activated. It can also be seen from the equation that when the mass of the milked milk is small the theoretical mixing temperature shows only a slight increase, such that it is not absolutely necessary to activate a cooling device when only small masses of amount of milk are expected.

With regard to the expected mixing temperature, it may make sense to cool the milk located in the tank more intensely in order to obtain a favorable initial value for the subsequent cooling steps.

The temperature of the amount of milked milk can be estimated and/or measured. An estimation of the temperature is especially advantageous when the method according to the invention is used in milking systems in which there are no temperature sensors for the amounts of milk. However, it is preferable to determine the temperature of the amount of milk by measurement. Especially, the temperature of the amount of milked milk is determined at the milking station, at the milk collecting container after the plate cooler and/or at the inlet to the cooling tank. Since the milk in the piping system from the milking station to the cooling tank goes through a certain path, the milk can in some cases cool off. The extent of cooling can be estimated here so that the temperature of the amount of milked milk at the milking station is measured while the temperature at the inlet into the cooling tank is estimated. From the expected temperature at the inlet into the cooling tank, information can be provided to the control system of a milk cooling arrangement. If cooling of the milk occurs, then based on consideration of the temperature measured at the milking station the cooling performance will be set too high.

In this case, with consideration of a safety factor, the cooling performance can be adjusted to the value of temperature estimated at the inlet into the cooling tank. This is not only the case when, during the streaming, the milk cools, but also when, on the way from the milking station to the cooling tank, heating of the milk might occur. In such a case the cooling performance must be higher than based on the temperature determined at the milking station.

The cooling performance necessary for cooling the milk is essentially dependent on the amount of milk milked. It is also necessary to provide sufficient cooling performance even in case of a maximum amount of milk obtained. Therefore, it is proposed that the amount of milk milked be predicted according to data specific to the individual animal or group or herd. With the aid of this measure, the necessary cooling performance can be provided as a function of the predicted amount of milk even before the milking processes. Hereby seasonal or lactation-related influences on the predicted amount of milk can be taken into consideration based on data on individual animals. When the method is conducted in this way, it is especially suitable for those milking systems in which the animals are led to the milking system at specified points in time.

The amount of milk milked can be predicted not only from data on individual animals, but also directly or indirectly. As a result of this the accuracy increases. The amount of milk can be determined by measuring the amount of milk or from data of a milk pump. The amount of milk is the amount of milk which would be obtained at the individual milking stations, and then there is also the possibility of combining several milking stations to groups and to determine the amount of milk milked in the group.

According to a still further advantageous embodiment of the method, it is proposed that a first approximate value be determined for the characteristic quantity from data on individual animals and the cooling device activated when the approximate value lies outside a tolerance field, especially when it exceeds a predetermined threshold value. With the aid of this step, it is achieved that the cooling device is activated soon enough to store the expected amount of milk in the cooling tank adequately. The approximate value can also be tracked which means that this approximate value is corrected with consideration of the actual conditions. This is especially advantageous when the milking duration of the animals is very different. Thus, for example, at a milking station an animal can be milked, while at another milking station the milking has not yet begun, whereby the milking process at the first milking station and the milking process at the second milking station overlap in time so that an increased amount of milk can be expected under certain circumstances by addition. In this way, the cooling performance can be not only increased but also decreased since, for example, at the first milking station the milking process was already completed while at the second milking station the milking process approaches the end.

In connection with the activation of the cooling device, it is of interest to find out when the cooling performance is queried. In this connection, according to another advantageous embodiment of the method, it is proposed that the time or times be determined at which the amount of milk milked arrives into the cooling tank. For this determination, the flow velocity of the milk is determined in at least one relevant point of the milking system.

When the milking system has several milking stations, it is proposed that at least one of the milking stations, preferably at all milking stations, at least one determination of the amount of milk milked be performed at the particular milking stations. This can be an actual determination of the amount of milk. Alternatively or additionally, theoretical determinations of the amount of milk can also be performed, where this is done based on data on individual animals.

The activation of the cooling device preferably occurs when at least one characteristic quantity lies outside a tolerance field, especially when it exceeds a predetermined threshold value. The characteristic quantity can be a system characteristic quantity which is composed of a number of characteristic quantities, whereby the individual characteristic quantities can be assigned to the individual milking stations.

The milking-station-specific characteristic quantities can be determined at the milking station itself. The determination of the characteristic quantities can also be determined centrally, preferably in a herd-management system. Hereby both milking-station-specific characteristic quantities as well as a system characteristic quantity can be determined.

In milking systems which have a number of milking stations and which are suitable for the milking of large herds, it is advantageous when several cooling tanks are provided. Hereby the individual stations or all can be connected with a cooling tank each. A design of a milking system is preferable in which the milking stations can be optionally connected to the cooling tanks or separated from them. In such a design of the milking system it is proposed that, depending on at least one characteristic quantity and/or depending on the expected and/or actually milked milk, this is led to different cooling tanks. The amount of milk can be the amount of milk of individual milking stations. There is also the possibility that groups of milking stations can be connected with the individual cooling tanks or separated from them.

A goal of the present invention is also to provide a control system of a milk cooling arrangement which can be realized with simple means.

This goal is achieved by the control system according to the invention according to claim 17. Advantageous embodiments and further developments of the control system are the objects of the dependent claims.

The control system of a milk cooling arrangement according to the invention with at least one cooling tank and at least one cooling device has a signal evaluation device which is provided with signals that correspond to milk-cooling-arrangement-related and milk-specific data of at least a few milking stations. A control element is connected to the signal evaluation unit and the milk cooling arrangement, which activates the milk cooling arrangement, especially a cooling device, as a function of the signals delivered by the signal evaluation unit and the control element.

According to an advantageous embodiment of the control system, it is proposed that at least one milking station have a milking station control, which is a component of the control system. By this embodiment of the control system, the milking station control can provide coordination of the control data of the milk cooling arrangement. The milking stations hereby have milking station controls with convenient display and setting possibilities. These can also be used for controlling the milk cooling arrangement.

The displays can be used for representing the parameters of the milk cooling arrangement as well as of the status of the milk cooling arrangement. As a result of this, greater convenience is created for the operator. Furthermore, as a result of this measure, the possibility is created that the operator can react more rapidly to possible irregularities during the milking process since these occur most frequently at the milking station. Also, the display and storage of the status of the milk cooling arrangement can be done at the milking station, so that the operator has the current data about the status of the milk cooling arrangement on location.

There is also a possibility that the signal evaluation unit be formed through a central data processing installation. It can be part of a plant management system, especially of the herd-management system. With the aid of the herd-management system, data, especially data on individual animals, can be transmitted to the signal evaluation device.

By coordination of the control of the milking station and the control of the milk cooling, the performance of the milk cooling arrangement can be improved. Thus, shorter cooling times and better utilization of the resources within the cooling device can be achieved. The setting of the parameters and the recording of the status of the milk cooling arrangement can be realized conveniently.

Further details and advantages will be explained with the aid of the practical example shown in the drawing without the object of the application being limited to this preferred practical example.

In the course of mechanization in dairy cattle keeping, information and control systems have been developed for the animal keeping operations. The information and control systems may be very different due to the extremely different sizes of operations, and properties specific to the country.

In modern dairy cattle operations one finds a number of control systems which deal with very different functions. This also applies especially to the information and control system in dairy cattle operations which use automatic milking systems. In automatic milking systems the milk cups are attached automatically to the teat of an animal. It is also known that characteristic quantities or processes in animal keeping operations can be controlled with the aid of sensors. It can relate for example to the milk output of an animal or of its sorting into an area provided for it. These characteristic quantities are selectively made available to the operator in the milking parlor. Furthermore, such characteristic quantities are sent to a central computer and processed there. In the central computer there is also a possibility of manual data acquisition and management. This central computer serves at the same time as a control and/or regulating unit for the components of a milking system. At the central computer, the essential control information of the dairy cattle operation can be recalled.

The practical example shown in the FIGURE indicates schematically the cooperation of several components of a milking system. The milking system has a milking parlor control 1, which is in connection with the milking parlor control equipment 2. The milking parlor control equipment communicates with the milking parlor control 1. The milking parlor control 1 also provides control of the milk pumps 3.

The milking parlor control 1 can be a control which controls a single milking station. Several milking parlor controls 1 can also be provided which control the individual milking stations, which are not shown. There is also the possibility that one milking parlor control is provided for several milking stations. In addition to these main variations, milking systems can also be produced which contain mixed forms of milking parlor controls. With the aid of the milking parlor control equipment 2, which controls the sensors that are not shown, milk-specific data are sent to the milking parlor control 1. These data contain information about the amount of milk milked, the temperature of the milk and preferably the specific heat capacity of the milk. Through the milk pump control 3, the milking parlor control 1 can be provided data regarding the amount of milked milk.

The milking parlor control 1 can furthermore contain information about the animal that is at the milking station at that moment. It is possible to provide the milking parlor control information continuously, but also regarding the exceeding of threshold values. These threshold values can be established with knowledge of the internal physical characteristics and settings of the control system of a milk cooling arrangement.

The milking parlor control can be a branched system, so that individual milking parlor controls or milking parlor equipment can be connected to the control system of a milk cooling arrangement. However, it is also possible to have a central process control, for example within a herd-management program. This herd-management program provides the necessary signals and data to the control system of a milk cooling arrangement.

The milking parlor control 1 can obtain the relevant information about the milked amount of milk from the activity of the milk pump. This information is provided by milk pump control 3. Moreover, the estimated time for the arrival of the milked milk to the cooling tank can also be derived from the activity of the milk pump and the sensors connected to it.

For several milking stations with several cooling tanks, the milking parlor control 1 can provide the coordination of the control data and milk flows. In this case it is helpful to transmit, for example, the actual tank capacity, which can be calculated from the capacities of the cooling tanks and the current filling amount. With the aid of these internal physical parameters, for example, filling level, remaining capacity, temperature, cooling performance, status of the cooling aggregates, etc., the milking parlor control can coordinate and optimize the loading of the cooling tanks with the milk that was just milked.

The milk cooling arrangement 4 is connected to the milking parlor control 1 for this purpose. The milk cooling arrangement 4 includes a tank control 5, a cooling tank 6, cooling devices 7, as well as tank sensors 8. The tank sensors 8 provide information about the current status of the cooling tank 6. The cooling aggregates 7 are connected to the tank control 8 and to the milking parlor control 1 using information technology in such a way that the milking parlor control and/or the tank control controls the cooling aggregate 7 according to the requirements.

The milking parlor control provides information about the temperature as well as about the amount of milk milked. From these quantities as well as from knowing the specific heat capacity of the amount of milk and the known physical parameters within the cooling tanks, the amount of heat that must be removed from the amount of milk milked can be calculated. That is, one can calculate the cooling performance necessary so that the temperature in the cooling tank remains within the set tolerance field. The temperature in the cooling tank is preferably 4° C.

If it is known at what time point milk arrives into the cooling tank, then, with consideration of the known cooling performance, the tank control and the cooling aggregates 7 can be activated correspondingly.

Instead of the determination of the amount of heat that has to be removed, a determination of a theoretical mixing temperature can also be performed. This determination is done with the following equation.

$${T}_{m} = {T}_{0} + \frac{( {m}_{T} {c}_{T} + {m}_{MT} {c}_{M} ) ( {T}_{T} - {T}_{0} ) + {m}_{M} \cdot {c}_{M} ( {T}_{M} - {T}_{0} )}{{m}_{T} {c}_{T} + {m}_{MT} \cdot {c}_{M} + {m}_{M} \cdot {c}_{M}}$$

where the symbols have the following meanings:

Tₘ mixing temperature,

T₀ reference temperature,

m_{T} mass of tank,

c_{T} specific heat capacity of the tank,

m_{MT} mass of the milk in the tank,

T_{T} temperature of the tank and milk,

m_{M} mass of milked milk,

c_{M} specific heat capacity of the milk and

T_{M} temperature of the milked milk.

If the predicted mixing temperature Tₘ lies within a set tolerance field, then there is no requirement for cooling the presently milked amount of milk. If the mixing temperature Tₘ leads to the fact that this is above a certain threshold value, then the amount of milk milked is cooled to the point that the mixing temperature is below the threshold value. If this is known beforehand from estimates, then the milk in the tank can also be cooled.

The milking parlor control can have displays and means of setting that belong to the control. By transferring the set parameters, the parameters can be transmitted to the tank control. As a rule, this is more convenient than carrying out the control oneself, since the operator is located mainly in the area of milking parlor control or in operating the herd management. The physical parameters of the milk cooling arrangement can also be displayed and requested at the milking parlor control.

By coordination of the milking parlor control and tank control, shorter cooling times and improved utilization of the resources within the milk cooling arrangement can be utilized. The setting of parameters and displaying of the status of the milk cooling arrangement can also be realized more conveniently. Moreover, more rapid adjustment to the changing states within a milking system can be achieved. The invention also offers the possibility of retrofitting existing milking systems without the necessity of a significantly high investment.

### REFERENCE LIST

1 Milking parlor control
2 Milking control equipment
3 Milk pump control
4 Milk cooling arrangement
5 Tank control
6 Cooling tank
7 Cooling aggregate
8 Tank sensor

1. A method for controlling a milk cooling system in a dairy, the method comprising the steps of:
obtaining cooling tank data from a cooling tank and milk data from milk flowing through a milking station:
providing the cooling tank and milk data to a controller for a milk cooling system; and
controlling the milk cooling system in response to the cooling tank and milk data.

2. The method according to claim 1, in which the step of obtaining the milk data comprises the step of obtaining the milk, temperature.

3. The method according to claim 1, in which the step of obtaining cooling tank data comprises the step of obtaining data contain information about the amount of milk located in the cooling tank.

4. The method according to claim 1, and further comprising the steps of:
obtaining milk history data on an individual animal's milking history; and,
providing the milking history data to the controller.

5. A method for cooling of milk in a milk cooling arrangement the method comprising the steps of:
a) determining an amount and temperature of milk flowing from a milking parlor;
b) determining an amount and temperature of milk in a cooling tank, to which the milk from the milking parlor will flow;
c) determining whether mixing the milk from the milking parlor with the milk in the cooling tank will cause the temperatures of the milk in the cooling tank to be outside of a predetermined temperature range; and
d) activating a cooling installation to maintain the temperature of the milk in the cooling tank within the predetermined temperature range.

6. The method according to claim 5, and further comprising the step of:
determining whether the potential temperature change to milk in the cooling tank requires pre-cooling of milk from the milking parlor before mixing with milk in the cooling tank.

7. The method according to claim 5, in which the temperature of the milk from the milking parlor is measured in the milking parlor.

8. The method according to claim 7, in which the temperature of the milk from the milking parlor is determined at a milking machine.

9. The method according to claim 5, in which the amount of milk from the milking parlor is predicted from previously obtained milking data on individual animals.

10. The method according to claim 5, in which the amount of milk from the milking parlor is determined by the step of:
measuring the amount of the milk pumped through a milk pump.

11. The method according to claim 8, and further comprising the step of:
determining from a milking history an approximate quantity of the milk to be received from individual animals; and
activating the cooling device when mixing that approximate quantity of milk with the milk in the cooling tank could cause the temperature of the milk in the cooling tank to be outside a predetermined range.

12. The method according to claim 5 and further comprising the step of:
determining a flow time in which the amount of milk from the milking parlor will arrive at the cooling tank.

13. The method according to claim 5 and further comprising the steps of:
determining milk amounts and temperatures at a plurality of milking stations in the milking parlor;
determining an approximate temperature increase in the milk in the cooling tank resulting from being mixed with the milk from the milking parlor; and
activating the cooling installation to maintain the milk in the cooling tank within the predetermined temperature range.

14. (canceled)

15. The method according to claim 13, in which the amount of milk from the milking parlor is determined in a central herd-management system.

16. The method according to claim 5, in which the step of activating the cooling installation comprises the step of:
directing milk from the milking parlor into different cooling tanks.

17. A control system of a milk cooling arrangement with at least one cooling tank comprising:
a signal evaluation device which is provided for providing signals which correspond to cooling-tank-specific and milk-specific data of at least one milking station; and
a controller for receiving signals from the signal evaluation unit and controlling a cooling installation as a function of the signals provided through the signal evaluation unit to the control element.

18. The control system according to claim 17, wherein the controller comprises:
at least one milking station control.

19. The control system according to claim 17, wherein the signal evaluation device comprises a central data processing installation.

20. The control system according to claim 17, and further comprising:
a herd-management system that transmits data on individual animals to the signal evaluation device.

21. The method according to claim 1, in which the signal evaluation device provides signals related to milk flow velocity.

22. The method according to claim 1, in which the signal evaluation device provides signals related to the specific heat capacity of the milk.

23. The method according to claim 1, in which the signal evaluation device provides signals related to the amount of milk located in the cooling tank.

24. The method according to claim 1, in which the signal evaluation device provides signals related to the amount of cooling tank residual capacity.

25. The method according to claim 1, in which the signal evaluation device provides signals related to the cooling tank temperature.

26. The method according to claim 1, in which the signal evaluation device provides signals related to the cooling tank cooling performance.

27. The method according to claim 1, in which the signal evaluation device provides signals related to the cooling tank cooling installation.
